(19) United States
(12) Patent Application Publication
(10) Pub. No.: US 2021/0256441 A1
(43) Pub. Date: Aug. 19, 2021

(54) Allocation of Resources in a Collaborative Supply Chain Using Blockchain Technology

(71) Applicant: International Business Machines Corporation, Armonk, NY (US)

(72) Inventors: Lohit Krishnan Namboodiri, Bangalore (IN); Pankaj S. Dayama, Bangalore (IN); Dhinakaran Vinayagamurthy, Bangalore (IN)

(21) Appl. No.: 16/793,265

(22) Filed: Feb. 18, 2020

(51) Int. Cl. G06Q 10/06; G06Q 10/08; G06Q 10/10; G06Q 30/02; G06Q 30/00; G06Q 50/26

(52) U.S. Cl. CPC G06Q 10/06315; G06Q 10/087; G06Q 50/265; G06Q 30/0206; G06Q 30/0185; G06Q 10/10

(57) ABSTRACT

Methods, systems, and computer program products for allocating resources in a collaborative supply chain using blockchain technology are provided herein. A computer-implemented method includes obtaining, via at least one blockchain network, information pertaining to distributor inventory of one or more resources; obtaining, via the at least one blockchain network, inputs from two or more vendors of the one or more resources; automatically determining (i) an allocation of at least a portion of the one or more resources across the two or more vendors and (ii) pricing information for the allocation attributed to each of the two or more vendors, wherein said automatic determination comprises executing a multi-party computation protocol among the distributor and the two or more vendors; and outputting (i) the allocation and (ii) the pricing information to the distributor and the two or more vendors.

### FIELD

The present application generally relates to information technology and, more particularly, to resource allocation techniques.

### BACKGROUND

A prominent leg of a supply chain network commonly includes distributors and retailers, wherein one distributor could plausibly be serving multiple retailers. Typically, after forecasting demands from consumers, retailers place advanced orders for particular resources with the distributor(s), and the distributor(s) arrange(s) for the ordered resources (typically such resources are of a certain level of quality). However, demand forecasts can be inaccurate. Accordingly, based on demand fluctuations, portions of the ordered resources may be wasted and/or transacted for at a disadvantage for one or more of the parties.

### SUMMARY

In one embodiment of the present invention, techniques for allocation of resources in a collaborative supply chain using blockchain technology are provided. An exemplary computer-implemented method can include obtaining, via at least one blockchain network, information pertaining to distributor inventory of one or more resources, and obtaining, via the at least one blockchain network, inputs from two or more vendors of the one or more resources, wherein the inputs comprise contract information (i) pertaining to one or more multi-party contracts between the distributor and at least one of the two or more vendors related to at least a portion of the one or more resources and (ii) pertaining to one or more bilateral contracts among the two or more vendors related to at least a portion of the one or more resources. The method also includes automatically determining (i) an allocation of at least a portion of the one or more resources across the two or more vendors and (ii) pricing information for the allocation attributed to each of the two or more vendors, wherein said automatic determination comprises executing a multi-party computation protocol among the distributor and the two or more vendors based at least in part on (a) analyzing the information pertaining to distributor inventor and the inputs from the two or more vendors, and (b) maintaining compliance with the contract information. Further, the method additionally includes outputting (i) the allocation and (ii) the pricing information to the distributor and the two or more vendors.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a flow diagram illustrating techniques according to an embodiment of the invention;

FIG. 3 is a system diagram of an exemplary computer system on which at least one embodiment of the invention can be implemented;

FIG. 4 depicts a cloud computing environment according to an embodiment of the present invention; and

FIG. 5 depicts abstraction model layers according to an embodiment of the present invention.

### DETAILED DESCRIPTION

As described herein, embodiments of the present invention include techniques and/or systems for allocation of resources in a collaborative supply chain using blockchain technology. For example, at least one embodiment includes dynamically reallocating resources (e.g., goods) between different entities (e.g., retailers and distributor(s)) to address demand fluctuations. Such an embodiment includes leveraging terms provided by one or more of the entities (e.g., the retailers) during a reallocation process. For instance, such terms can include a level of quality attributed to the resources, one or more price difference thresholds, etc.

As further detailed herein, one or more embodiments includes providing fair reallocation and pricing of resources to different participants in compliance with their respective parameters (e.g., contractual terms and/or obligations, etc.) while preserving potentially sensitive information (e.g., retailers typically do not want to reveal demand forecast to competitors). Also, one or more embodiments include implementing blockchain-based validation of inputs used by the reallocation and pricing techniques detailed herein, thereby addressing entity concerns with respect to the need for a trusted party to perform the reallocations.

At least one embodiment includes generating and/or implementing a secure multi-party computation (MPC) mechanism, which serves as an interactive protocol between mutually distrusting parties to compute a common function over the inputs (e.g., secret inputs) provided by the parties. Such an embodiment can include using an MPC mechanism that emphasizes properties of correctness, privacy, and integrity. With respect to a correctness property, if the parties adhere to the protocol, then the parties will obtain their corresponding correct outputs. With respect to a privacy property, the parties will not learn and/or be provided with potentially sensitive information pertaining to the input(s) of the other parties. Further, with respect to an integrity property, if any party deviates from the protocol, such deviation will be detected and/or reported (e.g., to the other parties).

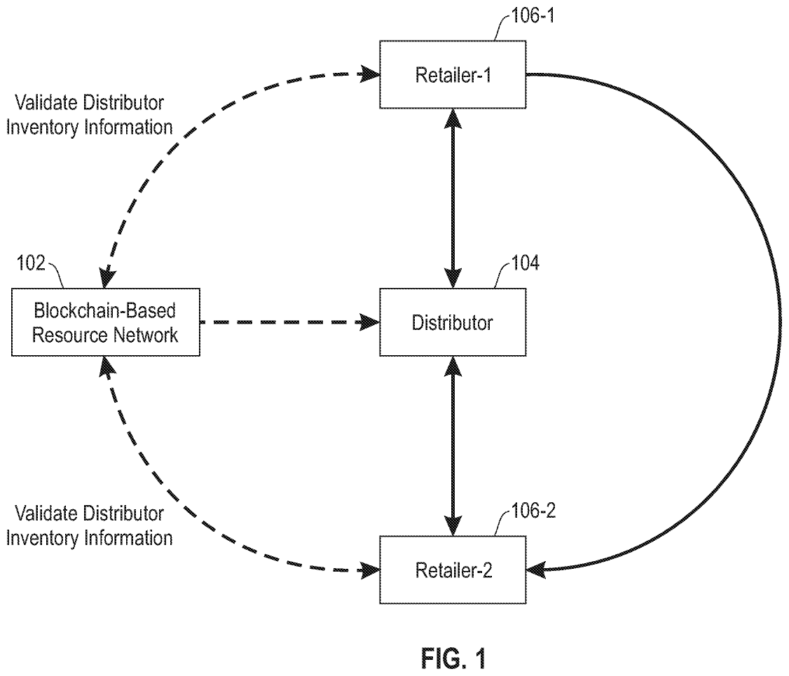

FIG. 1 is a diagram illustrating system architecture, according to an embodiment of the invention. By way of illustration, FIG. 1 depicts a blockchain-based resource network 102, a distributor 104, and retailers 106-1 and 106-2. In such an embodiment, all of the parties (e.g., distributor 104, and retailers 106-1 and 106-2) implement an MPC mechanism with pluggable modules for fair reallocation and fair pricing. Additionally, the MPC mechanism is connected to the blockchain-based resource network 102 to validate distributor inventory information.

More specifically, with respect to the inputs and outputs to and from such an MPC, an embodiment such as the embodiment depicted in FIG. 1 can include the following. The distributor 104 provides inventory information and each retailer (106-1 and 106-2) provides preference information and information pertaining to current demand. The MPC, based at least in part on analysis of such inputs, outputs to the distributor 104 an allocation to be provided to each retailer (106-1 and 106-2) along with respective pricing information. Accordingly, each retailer (106-1 and 106-2) will receive an indication of the units allocated thereto and the price to be paid for the allocation.

In one or more embodiments, an MPC mechanism (such as the one implemented in connection with the embodiment depicted in FIG. 1) can include the following steps. The distributor(s) commit(s) inventory information to a blockchain-based resource network (e.g., a food trust), while the suppliers (i.e., the entities that supply to the distributor(s)) have already committed their transactions with the distributor(s). For example, each distributor can compute the commitment (e.g., a hash) of their total inventory information, which can include information pertaining to the quantity and quality of the resources (e.g., goods such as food items, produce, etc.). The distributor-provided commitment is then stored in at least one ledger of the blockchain-based resource network. Additionally, this information can subsequently be verified by one or more retailers using endorsements (e.g., signatures) from the suppliers.

Additionally, in one or more embodiments, at least a portion of the parties involved (i.e., distributor(s) and retailers) will carry out an MPC protocol that includes validation of commitments from the participating distributor(s) and determining fair re-allocation and pricing of resources. Accordingly, commitments made by each participating distributor on the blockchain-based resource network are validated by every other participating party (i.e., retailers and other distributors) by checking one or more endorsements (e.g., signatures) from corresponding suppliers (providing evidence that the distributor is providing true and accurate information pertaining to their inventory of resources).

Also, as noted above, the MPC protocol (e.g., the SPDZ protocol (i.e., a multiparty computation scheme)) implemented by one or more embodiments includes determining fair re-allocation and pricing of resources. By way of example, a fair item allocation determination can be based at least in part on the utility and value of the resources, which can be derived from agreed-upon contract terms (between a distributor and a retailer), a retailer's stated price and/or quality preferences, a distributor's inventory information, etc. The notion of fairness, in such an embodiment, can be based, for example, on max-min fairness techniques and/or envy-freeness techniques. As would be appreciated by one skilled in the art, max-min fairness and envy-freeness are example properties that are satisfied by an allocation algorithm, such as detailed herein in connection with one or more embodiments. As detailed herein, such an MPC protocol takes into account the different preferences and current demand from the participating retailers and generates retailer specific allocation amounts and corresponding pricing information as an output.

Additionally, in at least one embodiment, each party's provided input is secret-shared to all other participating parties. By way merely of example, one or more embodiments can include carrying out such secret-sharing using Shamir's secret sharing scheme, wherein each party divides his or her input into different parts (referred to as “shares”) and separately sends the different parts to other parties (which ensures that any party can obtain the input only if all shares are combined). An MPC protocol implemented in connection with such an embodiment then includes performing one or more computations on the secret-shared inputs. Such computations can be carried out, for example, via a function represented as an arithmetic circuit with + and x gates, wherein the MPC computation proceeds gate-by-gate. For instance, for each gate, the parties use their shares_gate_input(s) to interactively compute the shares_gate_output. Further, subsequent to the parties obtaining and/or determining the shares of the function output gates (shares_function_gate_output), the parties communicate the shares_function_gate_output to one or more of the other participating parties in order to construct a final output. Accordingly, each shares_function_gate_output is shared with all other participating parties, and such parties can then combine the shares.

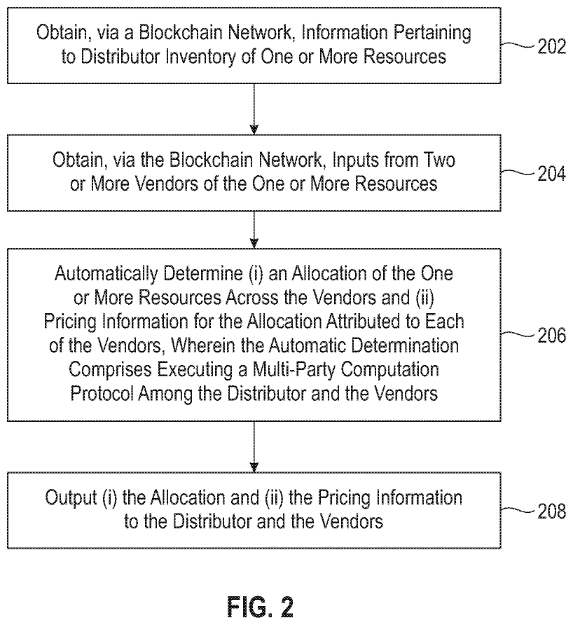

FIG. 2 is a flow diagram illustrating techniques according to an embodiment of the present invention. Step 202 includes obtaining, via at least one blockchain network, information pertaining to distributor inventory of one or more resources. The information pertaining to distributor inventory of one or more resources can include the quantity of the one or more resources and/or at least one indicator of quality of the distributor inventory of the one or more resources.

Step 204 includes obtaining, via the at least one blockchain network, inputs from two or more vendors (e.g., retailers) of the one or more resources, wherein the inputs comprise contract information (i) pertaining to one or more multi-party contracts between the distributor and at least one of the two or more vendors related to at least a portion of the one or more resources and (ii) pertaining to one or more bilateral contracts among the two or more vendors related to at least a portion of the one or more resources. In at least one embodiment, obtaining the inputs from the two or more vendors includes protecting sensitive information, in the inputs, pertaining to each of the vendors from the other vendors. Also, the inputs from the two or more vendors can include contract information between the distributor and at least one of the two or more vendors pertaining to at least a portion of the one or more resources, vendor-specific preferences pertaining to quantities of the one or more resources, and/or vendor-specific preferences pertaining to at least one indicator of quality attributed to the one or more resources.

Additionally, at least one embodiment includes enabling verification, via the at least one blockchain network, of the information pertaining to distributor inventory of one or more resources by the two or more vendors using one or more endorsements provided by at least one supplier of the distributor. Such verification can include using one or more endorsements provided by at least one supplier of the distributor.

Step 206 includes automatically determining (i) an allocation of at least a portion of the one or more resources across the two or more vendors and (ii) pricing information for the allocation attributed to each of the two or more vendors, wherein said automatic determination comprises executing a multi-party computation protocol among the distributor and the two or more vendors based at least in part on (a) analyzing the information pertaining to distributor inventor and the inputs from the two or more vendors, and (b) maintaining compliance with the contract information. Executing the multi-party computation protocol can include utilizing one or more max-min fairness techniques, utilizing one or more envy-freeness techniques, and/or carrying out a function, represented as an arithmetic circuit with multiple gates, on a gate-by-gate basis.

Step 208 includes outputting (i) the allocation and (ii) the pricing information to the distributor and the two or more vendors.

Additionally or alternatively, one or more embodiments include obtaining, via a blockchain network, (i) information pertaining to distributor inventory of one or more resources and (ii) inputs from two or more vendors of the one or more resources, wherein the inputs comprise contract information (a) pertaining to one or more multi-party contracts between the distributor and at least one of the two or more vendors related to at least a portion of the one or more resources and (b) pertaining to one or more bilateral contracts among the two or more vendors related to at least a portion of the one or more resources. Such an embodiment also includes verifying, by at least one of the two or more vendors via the blockchain network, at least a portion of the information pertaining to distributor inventory, wherein said verifying comprises using one or more endorsements provided by at least one supplier of the distributor. Further, such an embodiment includes automatically determining (i) an allocation of at least a portion of the one or more resources to at least one of the two or more vendors and (ii) pricing information for the allocation attributed to each of the at least one vendor, wherein said automatic determination comprises executing a multi-party computation protocol among the distributor and the two or more vendors based at least in part on (a) analyzing the information pertaining to distributor inventor and the inputs from the two or more vendors, and (b) maintaining compliance with the contract information. Also, such an embodiment additionally includes outputting, to the distributor and the at least one vendor, at least one notification identifying (i) the allocation and (ii) the pricing information.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

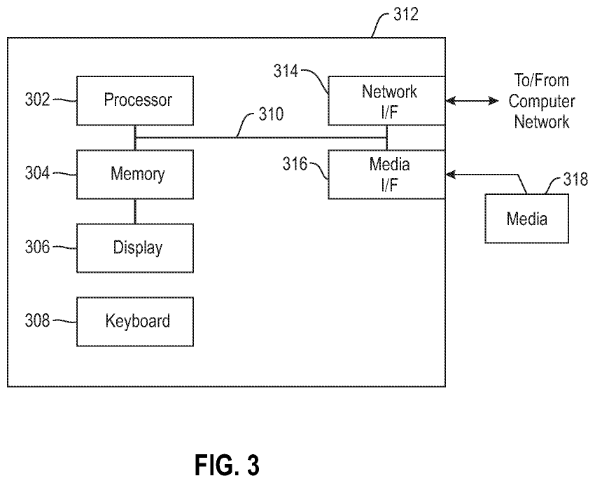

Additionally, an embodiment of the present invention can make use of software running on a computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

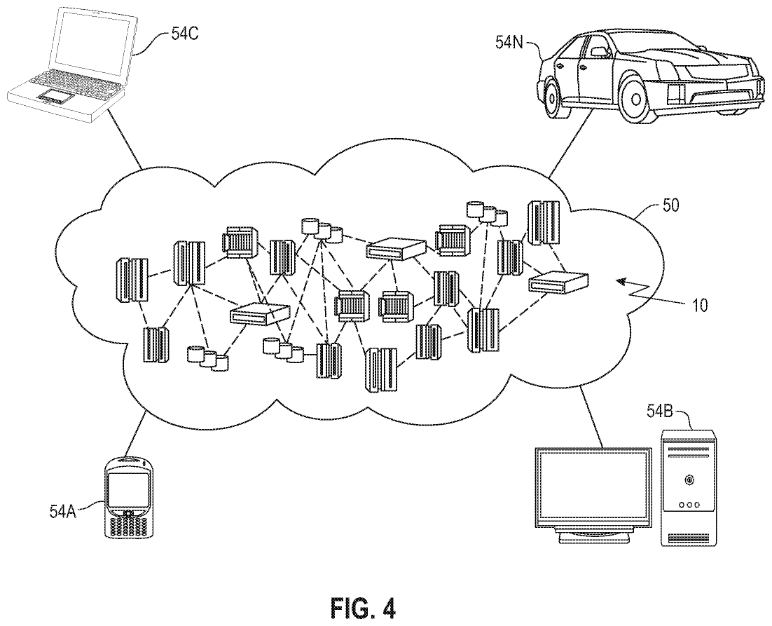

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

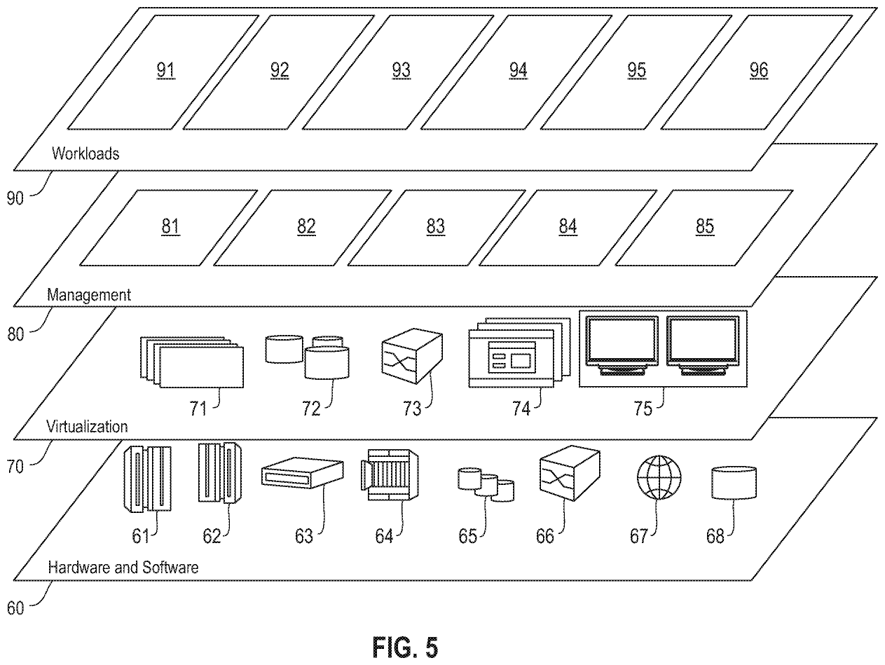

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and resource allocation 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, implementing blockchain-based validation of multi-party-provided inputs used by dynamic resource reallocation and pricing techniques.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, via at least one blockchain network, information pertaining to distributor inventory of one or more resources;
obtaining, via the at least one blockchain network, inputs from two or more vendors of the one or more resources, wherein the inputs comprise contract information (i) pertaining to one or more multi-party contracts between the distributor and at least one of the two or more vendors related to at least a portion of the one or more resources and (ii) pertaining to one or more bilateral contracts among the two or more vendors related to at least a portion of the one or more resources;
automatically determining (i) an allocation of at least a portion of the one or more resources across the two or more vendors and (ii) pricing information for the allocation attributed to each of the two or more vendors, wherein said automatic determination comprises executing a multi-party computation protocol among the distributor and the two or more vendors based at least in part on (a) analyzing the information pertaining to distributor inventor and the inputs from the two or more vendors, and (b) maintaining compliance with the contract information; and
outputting (i) the allocation and (ii) the pricing information to the distributor and the two or more vendors;
wherein the method is carried out by at least one computing device.

2. The computer-implemented method of claim 1, comprising:
enabling verification, via the at least one blockchain network, of the information pertaining to distributor inventory of one or more resources by the two or more vendors, using one or more endorsements provided by at least one supplier of the distributor.

3. The computer-implemented method of claim 2, wherein said verification comprises using one or more endorsements provided by at least one supplier of the distributor.

4. The computer-implemented method of claim 1, wherein said obtaining the inputs from the two or more vendors comprises protecting sensitive information, in the inputs, pertaining to each of the vendors from the other vendors.

5. The computer-implemented method of claim 1, wherein said executing the multi-party computation protocol comprises utilizing one or more max-min fairness techniques.

6. The computer-implemented method of claim 1, wherein said executing the multi-party computation protocol comprises utilizing one or more envy-freeness techniques.

7. The computer-implemented method of claim 1, wherein said executing the multi-party computation protocol comprises carrying out a function, represented as an arithmetic circuit with multiple gates, on a gate-by-gate basis.

8. The computer-implemented method of claim 1, wherein the inputs from the two or more vendors comprise vendor-specific preferences pertaining to quantities of the one or more resources.

9. The computer-implemented method of claim 1, wherein the inputs from the two or more vendors comprise vendor-specific preferences pertaining to at least one indicator of quality attributed to the one or more resources.

10. The computer-implemented method of claim 1, wherein the information pertaining to distributor inventory of one or more resources comprises the quantity of the one or more resources.

11. The computer-implemented method of claim 1, wherein the information pertaining to distributor inventory of one or more resources comprises at least one indicator of quality of the distributor inventory of the one or more resources.

12. A computer program product comprising a computer readable storage medium having program instructions embodied therewith, the program instructions executable by a computing device to cause the computing device to:
obtain, via at least one blockchain network, information pertaining to distributor inventory of one or more resources;
obtain, via the at least one blockchain network, inputs from two or more vendors of the one or more resources, wherein the inputs comprise contract information (i) pertaining to one or more multi-party contracts between the distributor and at least one of the two or more vendors related to at least a portion of the one or more resources and (ii) pertaining to one or more bilateral contracts among the two or more vendors related to at least a portion of the one or more resources;
automatically determine (i) an allocation of at least a portion of the one or more resources across the two or more vendors and (ii) pricing information for the allocation attributed to each of the two or more vendors, wherein said automatic determination comprises executing a multi-party computation protocol among the distributor and the two or more vendors based at least in part on (a) analyzing the information pertaining to distributor inventor and the inputs from the two or more vendors, and (b) maintaining compliance with the contract information; and
output (i) the allocation and (ii) the pricing information to the distributor and the two or more vendors.

13. The computer program product of claim 12, wherein the program instructions executable by the computing device further cause the computing device to:
enable verification, via the at least one blockchain network, of the information pertaining to distributor inventory of one or more resources by the two or more vendors, using one or more endorsements provided by at least one supplier of the distributor.

14. The computer program product of claim 12, wherein said obtaining the inputs from the two or more vendors comprises protecting sensitive information, in the inputs, pertaining to each of the vendors from the other vendors.

15. The computer program product of claim 12, wherein said executing the multi-party computation protocol comprises utilizing one or more max-min fairness techniques.

16. The computer program product of claim 12, wherein said executing the multi-party computation protocol comprises utilizing one or more envy-freeness techniques.

17. The computer program product of claim 12, wherein said executing the multi-party computation protocol comprises carrying out a function, represented as an arithmetic circuit with multiple gates, on a gate-by-gate basis.

18. A system comprising:
a memory; and
at least one processor operably coupled to the memory and configured for:
obtaining, via at least one blockchain network, information pertaining to distributor inventory of one or more resources;
obtaining, via the at least one blockchain network, inputs from two or more vendors of the one or more resources, wherein the inputs comprise contract information (i) pertaining to one or more multi-party contracts between the distributor and at least one of the two or more vendors related to at least a portion of the one or more resources and (ii) pertaining to one or more bilateral contracts among the two or more vendors related to at least a portion of the one or more resources;
automatically determining (i) an allocation of at least a portion of the one or more resources across the two or more vendors and (ii) pricing information for the allocation attributed to each of the two or more vendors, wherein said automatic determination comprises executing a multi-party computation protocol among the distributor and the two or more vendors based at least in part on (a) analyzing the information pertaining to distributor inventor and the inputs from the two or more vendors, and (b) maintaining compliance with the contract information; and
outputting (i) the allocation and (ii) the pricing information to the distributor and the two or more vendors.

19. The system of claim 18, wherein the at least one processor operably coupled to the memory is further configured for:
enabling verification, via the at least one blockchain network, of the information pertaining to distributor inventory of one or more resources by the two or more vendors, using one or more endorsements provided by at least one supplier of the distributor.

20. A computer-implemented method comprising:
obtaining, via a blockchain network, (i) information pertaining to distributor inventory of one or more resources and (ii) inputs from two or more vendors of the one or more resources, wherein the inputs comprise contract information (a) pertaining to one or more multi-party contracts between the distributor and at least one of the two or more vendors related to at least a portion of the one or more resources and (b) pertaining to one or more bilateral contracts among the two or more vendors related to at least a portion of the one or more resources;
verifying, by at least one of the two or more vendors via the blockchain network, at least a portion of the information pertaining to distributor inventory, wherein said verifying comprises using one or more endorsements provided by at least one supplier of the distributor;
automatically determining (i) an allocation of at least a portion of the one or more resources to at least one of the two or more vendors and (ii) pricing information for the allocation attributed to each of the at least one vendor, wherein said automatic determination comprises executing a multi-party computation protocol among the distributor and the two or more vendors based at least in part on (a) analyzing the information pertaining to distributor inventor and the inputs from the two or more vendors, and (b) maintaining compliance with the contract information; and
outputting, to the distributor and the at least one vendor, at least one notification identifying (i) the allocation and (ii) the pricing information;
wherein the method is carried out by at least one computing device.
